(19) United States
(12) Patent Application Publication
(10) Pub. No.: US 2026/0176472 A1
(43) Pub. Date: Jun. 25, 2026

(54) RADIATIVE COOLING PAINT AND RADIATIVE COOLING DEVICE INCLUDING PAINT COATING LAYER BASED ON RADIATIVE COOLING PAINT

(71) Applicant: Korea University Research and Business Foundation, Seoul (KR)

(72) Inventors: Heon LEE, Seoul (KR); Han Gyu LIM, Seoul (KR)

(73) Assignee: Korea University Research and Business Foundation, Seoul (KR)

(21) Appl. No.: 18/836,562

(22) PCT Filed: Feb. 16, 2024
(86) PCT No.: PCT/KR2024/095280

§ 371 Date: Aug. 7, 2024

(30) Foreign Application Priority Data
Feb. 20, 2023 (KR) 10-2023-0022227

(51) Int. Cl. C09D 5/33; C09D 7/40; C09D 7/61; C09D 7/63; C09D 7/65

(52) U.S. Cl. CPC C09D 5/004; C09D 7/61; C09D 7/63; C09D 7/65; C09D 7/68; C09D 7/69

(57) ABSTRACT

The present invention relates to a radiative cooling paint and a radiative cooling device including a paint coating layer based on the radiative cooling paint. The radiative cooling paint according to an embodiment of the present invention includes metal organic framework (MOF) particles; a binder for binding the metal organic framework; and a solvent in which a mixture of the metal organic framework particles and the binder is dissolved and dispersed, wherein the metal organic framework particles are formed of a metal material, an organic material and a plurality of voids, scatter and reflect incident sunlight including the near-infrared rays based on a difference in refractive index between the metal organic framework particles and the binder at an interface between the metal organic framework particles and the binder, and additionally scatter and reflect the incident sunlight based on the plurality of voids.

### TECHNICAL FIELD

The present invention relates to a radiative cooling paint and a radiative cooling device including a paint coating layer based on the radiative cooling paint, and more particularly to a technology of providing a radiative cooling paint including metal organic framework particles with a large surface area and voids and implementing a radiative cooling device including a paint coating layer formed using the radiative cooling paint to maximize the reflection of incident sunlight including near-infrared rays.

### BACKGROUND ART

Radiative cooling occurs when heat transfer occurs through a spontaneous, energy-free process called infrared radiation (emission).

Since the thermal energy of a cooling body is radiated out of the Earth's atmosphere rather than into the surrounding environment of the cooling body, this is a new technology allowing to be cooled to a temperature lower than the surrounding temperature without consuming energy.

That is, heat exchange by radiation from a cooling body to the outside of the Earth's atmosphere is accomplished by thermal radiation (infrared radiation), a spontaneous process that does not require energy.

The key to zero-energy radiative cooling is to reflect incident sunlight as much as possible without absorbing it.

In addition, it is to radiate its thermal energy to the outside as much as possible. The emission of thermal energy can be realized through the absorption and emission of long-wavelength infrared rays of 8 μm to 13 μm which is a wavelength range corresponding to the sky window.

For example, in broad daylight when the sun shines, the internal temperature of a black car that absorbs light easily rises, but in the case of a white car that does not absorb light and reflects it well, the temperature rises relatively less.

The surface of a white car, which does not absorb or reflect sunlight well, reflects light in the UV-visible-near-infrared wavelength range, i.e., incident sunlight, as much as possible to minimize the inflow of heat energy due to sunlight absorption.

At the same time, if 100% of sunlight is not reflected and more thermal energy than the incoming thermal energy is discharged to the outside through the infrared radiation of the sky window which is not absorbed by the earth's atmosphere, the car's temperature can be cooled to lower than the surrounding temperature.

The Earth's atmosphere contains small amounts of water vapor and carbon dioxide, and the like in addition to nitrogen, oxygen, and argon, and water vapor and carbon dioxide gas absorb some of the long-wavelength infrared rays that the Earth radiates to the outside, suppressing radiation to the outside.

A representative example is the “greenhouse effect.” As the concentration of carbon dioxide in the Earth's atmosphere increases, the emission of long-wavelength infrared rays emitted by the Earth into space is interrupted, preventing heat from being discharged from the Earth into space. This causes the Earth's temperature to rise.

However, long-wavelength infrared rays from the sky window are not absorbed by the Earth's atmosphere and are easily radiated out of the Earth's atmosphere.

Various types of radiative cooling devices are being studied. Initially, a radiative cooling device in the form of a multilayer thin film deposited on a substrate was proposed.

A silver (Ag) thin film is deposited on a substrate to reflect incident sunlight, and a multilayer thin film of materials that are transparent to incident sunlight and can absorb long-wavelength infrared rays well and radiate to the outside is laminated on the silver (Ag) thin film to construct a device.

In addition, a radiative cooling device in the form of a polymer film wherein a silver (Ag) thin film for solar light reflection is deposited on one side of the polymer film and ceramic microparticles for long-wavelength infrared radiation are dispersed inside the film was also proposed.

Both the devices used specular reflection which reflects incident sunlight like a mirror by using a metal thin film such as Ag to reflect incident sunlight.

radiative cooling can be performed by reflecting all wavelengths of incident sunlight without absorbing them using white scattering reflection, which does not have a mirror-like appearance by scattering and reflecting light for all wavelengths of incident sunlight, instead of specular reflection.

In particular, white scattering reflection does not use expensive silver (Ag) thin films, so manufacturing costs are lower. In addition, since there is no deterioration in product performance due to the deterioration of silver (Ag) thin films, the lifespan of products is longer, making them more suitable for manufacturing radiative cooling devices.

### DISCLOSURE

### Technical Problem

Therefore, the present invention has been made in view of the above problems, and it is one object of the present invention to provide a radiative cooling paint containing metal-organic structural particles with a large surface area and voids to maximize the reflection of incident sunlight including near-infrared rays, and implement a radiative cooling device including a paint-coating layer formed using the radiative cooling paint.

It is another object of the present invention to achieve the same or improved radiative cooling performance, even if the thickness of a paint coating layer is reduced, by replacing ceramic particles with metal organic framework particles or adding metal organic framework particles according to the present invention to manufacture a radiative cooling paint. As a result, painting workability can be improved because thick coating is not required.

It is still another object of the present invention to provide a radiative cooling device that has excellent radiative cooling performance, even if the content of a polymer binder increases, based on the effective scattering promotion of incident sunlight due to metal organic framework particles, and that includes a paint coating layer having improved durability due to the increased polymer binder content.

It is still another object of the present invention to provide radiative cooling performance using a radiative cooling paint having high heat dissipation ability regardless of day or night because there is no increase in temperature due to incident sunlight during daytime, and a paint coating layer formed using the radiative cooling paint.

It is still another object of the present invention to provide a radiative cooling paint capable of minimizing the absorption of incident sunlight even during the day when sunlight is shining when applied to devices installed outdoors, maintaining heat dissipation through long-wavelength infrared radiation well, and effectively transferring the energy of a heat source to a surface due to excellent thermal conductivity, thereby having further improved heat dissipation performance.

It is yet another object of the present invention to provide a radiative cooling paint that can be installed outdoors, such as in data centers, communication equipment, relay facilities, etc., and that can be used as a method to solve problems caused by the temperature of the equipment increasing due to internal heat.

### Technical Solution

In accordance with an aspect of the present invention, the above and other objects can be accomplished by the provision of a radiative cooling paint, including: metal organic framework (MOF) particles; a binder for binding the metal organic framework; and a solvent in which a mixture of the metal organic framework particles and the binder is dissolved and dispersed, wherein the binder absorbs and radiates long-wavelength infrared rays of 8 μm to 13 μm, has a plurality of absorption peaks in the long-wavelength infrared rays, and is formed of a polymer resin that does not absorb near-infrared rays in a range of 0.7 μm to 3 μm, and the metal organic framework particles are formed of a metal material, an organic material and a plurality of voids, scatter and reflect incident sunlight including the near-infrared rays based on a difference in refractive index between the metal organic framework particles and the binder at an interface between the metal organic framework particles and the binder, and additionally scatter and reflect the incident sunlight based on the plurality of voids.

The mixture of the radiative cooling paint may further include at least one particle of ceramic particles and polymer particles, wherein the ceramic particles and the polymer particles absorb and radiate the long-wavelength infrared rays, supplement absorption and radiation of long-wavelength infrared rays by the binder to increase emissivity of the long-wavelength infrared rays of 8 μm to 13 μm, and additionally scatter and reflect the incident sunlight based on a difference in refractive index between the binder and the plural voids.

The ceramic particles may include at least one of TiO₂, Al₂O₃, h-BN, ZrO₂, SiO₂, CaCO₃, BaSO₄, MgO, Y₂O₃, YSZ, BeO, MnO, ZnO, SiC and AlN, and the polymer particles may include at least one of dipentaerythritol hexaacrylate (DPHA), polytetrafluoroethylene (PTFE), polydimethylsiloxane (PDMS), polymethyl methacrylate (PMMA), polyurethane acrylate (PUA), ethylene tetra fluoro ethylene (ETFE), polyvinylidene fluoride (PVDF), an acrylic polymer, a polyester-based polymer and a polyurethance-based polymer.

The metal organic framework particles may include at least one white metal organic framework particle of ZIF-8, MOF-867 and CAU-1.

The metal organic framework particles may be included in a content ratio of 50% to 85% in the mixture, and when the content ratio increases, a reflectance of the near-infrared rays may increase and a transmittance and absorbance thereof may be decreased.

The metal organic framework particles may have a size of 0.1 μm to 5 μm, and each of the plurality of voids may have a size of less than 5 μm.

The binder may include a mixture of at least one polymer resin of polyurethane resin, fluorine resin, polyethylene resin, polyacrylate resin, PDMS and PVC.

In accordance with another aspect of the present invention, provided is a radiative cooling device, including a paint coating layer formed using a radiative cooling paint, wherein the radiative cooling paint includes metal organic framework (MOF) particles; a binder for binding the metal organic framework; and a solvent in which a mixture of the metal organic framework particles and the binder is dissolved and dispersed, wherein the binder absorbs and radiates long-wavelength infrared rays of 8 μm to 13 μm, has a plurality of absorption peaks in the long-wavelength infrared rays, and is formed of a polymer resin that does not absorb near-infrared rays in a range of 0.7 μm to 3 μm, and the metal organic framework particles are formed of a metal material, an organic material and a plurality of voids, scatter and reflect incident sunlight including the near-infrared rays based on a difference in refractive index between the metal organic framework particles and the binder at an interface between the metal organic framework particles and the binder, and additionally scatter and reflect the incident sunlight based on the plurality of voids.

The metal organic framework particles may include at least one white metal organic framework particle of ZIF-8, MOF-867 and CAU-1.

The metal organic framework particles may be included in a content ratio of 50% to 85% in the mixture, and when the content ratio increases, a reflectance of the near-infrared rays may increase and a transmittance and absorbance thereof may be decreased.

When the content ratio of the metal organic framework particles in the mixture increases, a reflectance, transmittance and absorbance of the near-infrared rays may be maintained even if a coating thickness of the paint coating layer is reduced according to the increased content ratio, and a reflectance of the near-infrared rays may increase and a transmittance and absorbance thereof may be reduced even if the coating thickness is not changed.

The metal organic framework particles may have a size of 0.1 μm to 5 μm, and each of the plurality of voids may have a size of less than 5 μm.

### Advantageous Effects

The present invention can implement a radiative cooling paint containing metal-organic structural particles with a large surface area and voids to maximize the reflection of incident sunlight including near-infrared rays, and implement a radiative cooling device including a paint-coating layer formed using the radiative cooling paint.

The present invention can achieve the same or improved radiative cooling performance, even if the thickness of a paint coating layer is reduced, by replacing ceramic particles with metal organic framework particles or adding metal organic framework particles according to the present invention to manufacture a radiative cooling paint. As a result, painting workability can be improved because thick coating is not required.

The present invention can provide a radiative cooling device that has excellent radiative cooling performance, even if the content of a polymer binder increases, based on the effective scattering promotion of incident sunlight due to metal organic framework particles, and that includes a paint coating layer having improved durability due to the increased polymer binder content.

The present invention can provide radiative cooling performance using a radiative cooling paint having high heat dissipation ability regardless of day or night because there is no increase in temperature due to incident sunlight during daytime, and a paint coating layer formed using the radiative cooling paint.

The present invention can provide a radiative cooling paint capable of minimizing the absorption of incident sunlight even during the day when sunlight is shining when applied to devices installed outdoors, maintaining heat dissipation through long-wavelength infrared radiation well, and effectively transferring the energy of a heat source to a surface due to excellent thermal conductivity, thereby having further improved heat dissipation performance.

The present invention can provide a radiative cooling paint that can be installed outdoors, such as in data centers, communication equipment, relay facilities, etc., and that can be used as a method to solve problems caused by the temperature of the equipment increasing due to internal heat.

### DESCRIPTION OF DRAWINGS

FIGS. 1 and 2 illustrate a radiative cooling paint according to an embodiment of the present invention and a radiative cooling device including a paint coating layer based on the radiative cooling paint.

FIG. 3 illustrates metal organic framework (MOF) particles according to an embodiment of the present invention.

FIG. 4 illustrates metal organic framework particles according to an embodiment of the present invention and a paint coating layer coated with a paint containing the metal organic framework particles.

FIGS. 5A and 5B illustrate electron microscope images of a paint coating layer according to an embodiment of the present invention.

FIGS. 6 to 8 illustrate the optical characteristics of a radiative cooling device including a paint coating layer based on the radiative cooling paint according to an embodiment of the present invention.

### BEST MODE

Hereinafter, preferred embodiments of the present invention will be described in detail with reference to the accompanying drawings.

However, it should be understood that the present invention is not limited to the embodiments according to the concept of the present invention, but includes changes, equivalents, or alternatives falling within the spirit and scope of the present invention.

In the following description of the present invention, detailed description of known functions and configurations incorporated herein will be omitted when it may make the subject matter of the present invention unclear.

In addition, the terms used in the specification are defined in consideration of functions used in the present invention, and can be changed according to the intent or conventionally used methods of clients, operators, and users. Accordingly, definitions of the terms should be understood on the basis of the entire description of the present specification.

In description of the drawings, like reference numerals may be used for similar elements.

The singular expressions in the present specification may encompass plural expressions unless clearly specified otherwise in context.

In this specification, expressions such as “A or B” and “at least one of A and/or B” may include all possible combinations of the items listed together.

Expressions such as “first” and “second” may be used to qualify the elements irrespective of order or importance, and are used to distinguish one element from another and do not limit the elements.

It will be understood that when an element (e.g., first) is referred to as being “connected to” or “coupled to” another element (e.g., second), the first element may be directly connected to the second element or may be connected to the second element via an intervening element (e.g., third).

As used herein, “configured to” may be used interchangeably with, for example, “suitable for”, “ability to”, “changed to”, “made to”, “capable of”, or “designed to” in terms of hardware or software.

In some situations, the expression “device configured to” may mean that the device “may do ˜” with other devices or components.

For example, in the sentence “processor configured to perform A, B, and C”, the processor may refer to a general purpose processor (e.g., CPU or application processor) capable of performing corresponding operation by running a dedicated processor (e.g., embedded processor) for performing the corresponding operation, or one or more software programs stored in a memory device.

In addition, the expression “or” means “inclusive or” rather than “exclusive or”.

That is, unless mentioned otherwise or clearly inferred from context, the expression “x uses a or b” means any one of natural inclusive permutations.

Terms, such as “unit” or “module”, etc., should be understood as a unit that processes at least one function or operation and that may be embodied in a hardware manner, a software manner, or a combination of the hardware manner and the software manner.

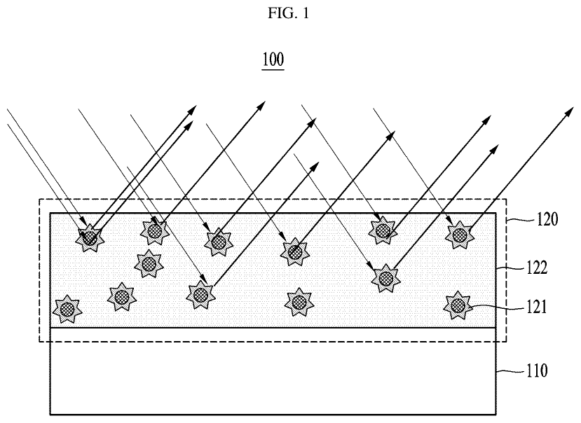

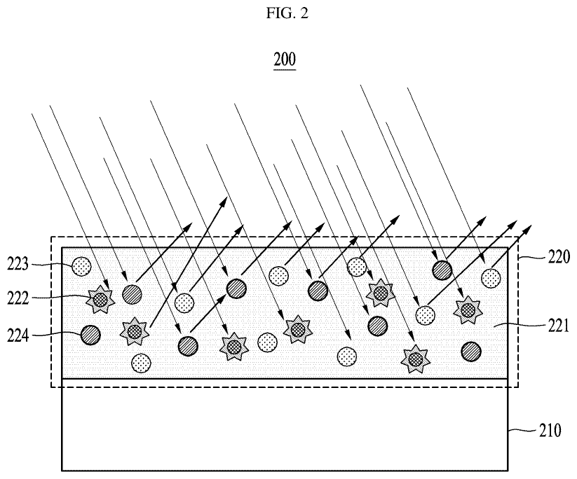

FIGS. 1 and 2 illustrate a radiative cooling paint according to an embodiment of the present invention and a radiative cooling device including a paint coating layer based on the radiative cooling paint.

FIG. 1 illustrates a radiative cooling paint made of a mixture of a binder and metal organic framework particles according to an embodiment of the present invention, and a radiative cooling device including a paint coating layer based on the radiative cooling paint.

Referring to FIG. 1, a radiative cooling device 100 according to an embodiment of the present invention has a structure wherein a paint coating layer 120 is formed on a substrate 110.

For example, the paint coating layer 120 is formed using a radiative cooling paint. For example, the substrate 110 may include any surface which can be coated with a paint.

The radiative cooling device 100 according to an embodiment of the present invention is a radiation cooling device that scatters and reflects incident sunlight using a mixture of metal organic framework particles.

Radiative cooling can also be performed by reflecting all incident sunlight rather than absorbing it using white scattering reflection that scatters and reflects light for all wavelengths of incident sunlight to appear in white without a mirror-like appearance.

In particular, since white scattering reflection does not use expensive silver (Ag) thin films, manufacturing costs are lower, and since there is no deterioration in product performance due to deterioration of the silver (Ag) thin film, the product lifespan is extended, making it more suitable for manufacturing a radiative cooling device.

To efficiently cause white scattering reflection, ceramic microparticles of a similar size to the wavelength to be reflected are required, and a binder material to connect these microparticles is also required.

A polymer material is very suitable as a binder material. A polymer is a very competitive material because it is easy to mass produce, is cheap, and can control physical properties in various ways.

Therefore, if a zero-energy radiative cooling device can be constructed using a polymer, various products can be made inexpensively and processability is also improved, which has many advantages.

Many polymer resin and ceramic microparticles themselves have a high emissivity in the sky window of 8 μm to 13 μm, are transparent to incident sunlight and do not absorb well.

By combining only these materials, a white radiation cooling device can be created. Since it is a combination of a polymer resin and ceramic nanoparticles, a radiative cooling device can also be implemented in the form of “paint”.

That is, when various polymer resins and ceramic fine particles are dissolved and dispersed in a solvent, it is a general form of paint.

This paint is applied (coated) to various surfaces to form a paint-coating layer, and the formed coating film maximizes incident sunlight and minimizes absorption. When the paint performs radiative cooling by maximizing the radiation of long-wavelength infrared rays of 8 μm to 13 μm, it can become a radiative cooling paint.

Compared to other types of radiative cooling devices, the advantage of radiative cooling paint is that it is applied on any surface, on which paint can be applied, to form a film, and the formed film performs radiative cooling, allowing for a variety of applications.

That is, the paint coating layer 120 according to an embodiment of the present invention is based on a radiative cooling paint that performs radiative cooling by maximally reflecting incident sunlight and maximizing the radiation of long-wavelength infrared rays.

A radiative cooling paint for forming the paint coating layer 120 according to an embodiment of the present invention includes metal organic framework particles 121; a binder 122 for binding the metal organic framework particles 121; and a solvent in which a mixture of the metal organic framework particles and the binder is dissolved and dispersed.

For example, the paint coating layer 120 has a form wherein the plural metal organic framework particles 121 are dispersed in the binder 122.

According to an embodiment of the present invention, the binder 122 may be formed of a polymer resin that absorbs and radiates long-wavelength infrared rays of 8 μm to 13 μm, has a plurality of absorption peaks in long-wavelength infrared rays, and does not absorb near-infrared rays in a range of 0.7 μm to 3 μm.

For example, the metal organic framework particles 121 are composed of a metal material, an organic material and a plurality of voids, scatter and reflect incident sunlight including near-infrared rays based on a difference in refractive index with the binder 122 at the interface with the binder 122, and additionally scatter and reflect incident sunlight based on a plurality of voids.

According to an embodiment of the present invention, the metal organic framework particles 121 may include at least one white metal organic framework particle selected from among ZIF-8, MOF-867 and CAU-1.

For example, the metal organic framework particles 121 are included in a content ratio of 50% to 85% in the mixture, and when the ratio increases, they can increase the reflectance of near-infrared rays and decrease the transmittance and absorbance thereof.

According to an embodiment of the present invention, the size of the metal organic framework particles 121 may be 0.1 μm to 5 μm, and the size of each of the plural voids may be less than 5 μm.

The binder 122 may include a mixture of at least one polymer resin selected from among polyurethane resin, fluorine resin, polyethylene resin, polyacrylate resin, PDMS and PVC.

The radiative cooling paint may be made of a polymer resin that scatters light to effectively reflect incident sunlight.

The radiative cooling paint according to an embodiment of the present invention includes white metal organic framework particles.

The radiative cooling paint should reflect 90% or more of incident sunlight. In the case of white metal organic framework particles, scattering reflection also occurs at the interface between metal organic framework particles and a polymer binder, but due to the pores of the metal organic framework material itself, incident sunlight is additionally scattered and reflected, improving radiative cooling performance.

Light scattering occurs at the interface between metal organic framework particles and a polymer binder, and in voids inside metal organic framework particles, effectively reflecting incident sunlight.

Therefore, the present invention provides a radiative cooling paint containing metal-organic structural particles with a large surface area and voids to maximize the reflection of incident sunlight including near-infrared rays, and implements a radiative cooling device including a paint-coating layer formed using the radiative cooling paint.

FIG. 2 illustrates a radiative cooling paint formed of a mixture of a binder, ceramic particles, polymer particles and metal organic framework particles according to an embodiment of the present invention, and a radiative cooling device including a paint coating layer based on the radiative cooling paint.

Referring to FIG. 2, a radiative cooling device 200 according to an embodiment of the present invention has a structure wherein a paint coating layer 220 is formed on a substrate 210.

The paint coating layer 220 includes a binder 221, metal organic framework particles 222, ceramic particles 223 and polymer particles 224.

The paint coating layer 220 further includes the ceramic particles 223 and polymer particles 224 which are not included in the radiative cooling paint shown in FIG. 1.

In other words, the mixture of the radiative cooling paint may further include at least one particle of the ceramic particles 223 and the polymer particles 224.

According to an embodiment of the present invention, the ceramic particles 223 and the polymer particles 224 may absorb and radiate long-wavelength infrared rays, supplement the absorption and radiation of the long-wavelength infrared rays of the binder 221 to increase the emissivity of long-wavelength infrared rays in a range of 8 μm to 13 μm, and additionally scatter and reflect incident sunlight based on a difference in refractive index between the binder 221 and the plural voids.

The ceramic particles 223 may include at least one of TiO₂, Al₂O₃, h-BN, ZrO₂, SiO₂, CaCO₃, BaSO₄, MgO, Y₂O₃, YSZ, BeO, MnO, ZnO, SiC and AlN.

The polymer particles 224 may include at least one of dipentaerythritol hexaacrylate (DPHA), polytetrafluoroethylene (PTFE), polydimethylsiloxane (PDMS), polymethyl methacrylate (PMMA), polyurethane acrylate (PUA), ethylene tetra fluoro ethylene (ETFE), polyvinylidene fluoride (PVDF), an acrylic polymer, a polyester-based polymer and a polyurethance-based polymer.

According to an embodiment of the present invention, the paint coating layer 220 exhibits a maximum emissivity of about 90% to 95% in long-wavelength infrared rays in a range of 8 μm to 13 μm based on the binder 221, the ceramic particles 223 and the polymer particles 224.

To maximize the emissivity, materials such as the binder 221, the ceramic particles 223 and the polymer particles 224 may be selected and combined.

For example, the ceramic particles 223 and polymer particles 224 in the paint coating layer 220 also improve the scattering and reflection of incident sunlight of the metal organic framework particles 222 as incident sunlight scatters and reflects.

In the paint coating layer 220, a plurality of ceramic particles, a plurality of polymer particles and a plurality of metal organic framework particles are dispersed inside the binder.

To achieve the sufficient reflection of incident sunlight even with a thin coating thickness, additional light scattering should be triggered in addition to the scattering of only ceramic particles and a polymer binder in existing radiative cooling paints.

For this, the radiative cooling paint according to an embodiment of the present invention enhances light scattering inside the paint coating layer 220 by using the metal organic framework particles 222 containing voids therein.

The refractive index of voids is 1.0, and the difference in refractive index between the binder 221 and the ceramic particles 223 is large, so light scattering around pores is very effective, providing sufficiently high solar reflectance and sufficiently low solar transmittance even with the thickness of the paint coating layer 220.

In addition, even if a small number of voids are contained, the sky window emissivity is not affected at all.

The radiative cooling device 200 according to an embodiment of the present invention uses white metal organic framework particles with a large specific surface area and voids inside to reduce incident sunlight absorption and maximize reflection compared to radiative cooling paints of existing inventions.

Metal-organic structure particles can replace ceramic particles to form a radiative cooling paint, and these particles can also be used together to form a radiative cooling paint.

Therefore, the present invention can provide a radiative cooling device that has excellent radiative cooling performance, even if the content of a polymer binder increases, based on the promotion of effective incident sunlight scattering by metal organic framework particles and that includes a paint coating layer having improved durability due to the increased polymer binder content.

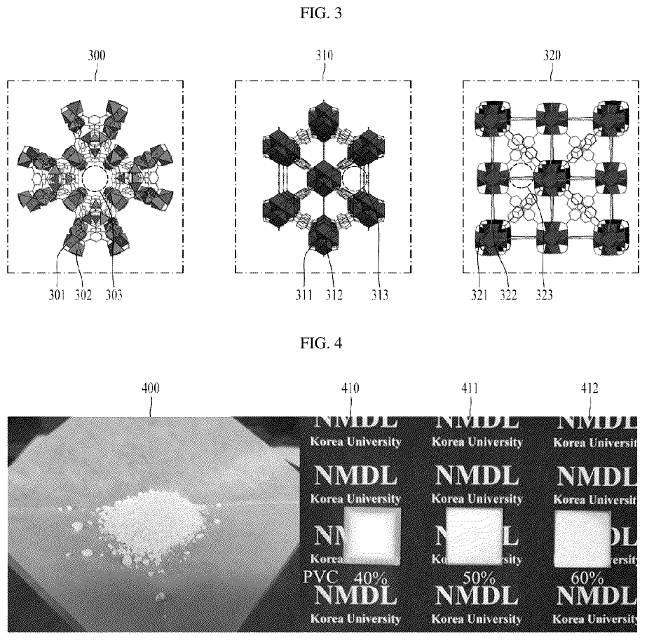

FIG. 3 illustrates metal organic framework (MOF) particles according to an embodiment of the present invention.

FIG. 3 illustrates the crystal structures of metal organic framework (MOF) particles according to an embodiment of the present invention.

MOF particles can form various types of crystal structures wherein functional groups connect metal ions and pores are formed therebetween.

Referring to FIG. 3, first metal organic framework particles are HKUST-1/MOF-199 and form a crystal structure 300.

In the crystal structure 300 of the first metal organic framework particles, a functional group 301 connects metal ions 302 to each other, and voids 303 are formed therein.

Second metal organic framework particles are UiO-66 and form a crystal structure 310.

In the crystal structure 310 on the second metal organic framework particles, a functional group 311 connects metal ions 312 to each other, and voids 313 are formed therein.

Third metal organic framework particles are UiO-67 and form a crystal structure 320.

In the crystal structure 320 of the third metal organic framework particles, a functional group 321 connects metal ions 322 to each other, and voids 323 are formed therein.

The metal organic framework (MOF) is a new material wherein metal ions and organic functional groups are combined to form a three-dimensional structure. The MOF material itself is easy to synthesize and contains many pores, thereby being used in various fields such as CO₂ separation and hydrogen (H₂) storage.

MOF particles have countless micropores on the surface thereof, so the surface area thereof is maximized.

MOF particles form a lattice structure through self-assembly in which metal atoms are connected to organic molecules containing carbon.

ZIF-8 (Zeolitic Imidazolate Framework) is a zeolite-like material composed of Si and Al, and is MOF composed of Zn and an imidazolate molecule.

Like the crystal structures 300 to 320, ZIF-8 is composed of metal ions and organic functional groups and contains a plurality of voids.

Meanwhile, ZIF-8, MOF-867 and CAU-1 are also white metal organic framework particles, composed of metal ions and organic functional groups, and contain a plurality of voids, so they can scatter and reflect incident sunlight for radiative cooling.

MOF particles have a very large specific surface area and can adjust the size of voids, so they can be used in a catalyst, a sensor, gas storage, a gas and liquid adsorbent, a secondary battery, a radiative cooling paint and a radiative cooling device.

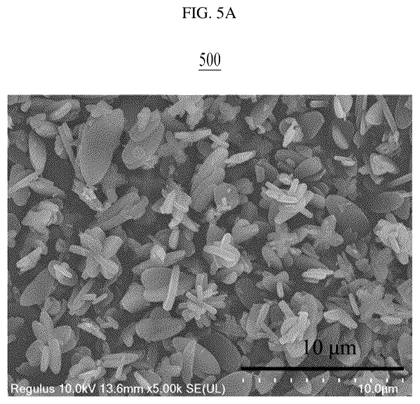

FIG. 4 illustrates metal organic framework particles according to an embodiment of the present invention and a paint coating layer coated with a paint containing the metal organic framework particles.

FIG. 4 illustrates metal organic framework particles according to an embodiment of the present invention and a paint coating layer coated with a paint containing the metal organic framework particles.

Referring to FIG. 4, an image 400 illustrates a powder formed of metal organic framework particles.

An image 410 illustrates a mixture in which a metal organic framework particle powder is contained in a content of about 40%.

An image 411 illustrates a mixture in which a metal organic framework particle powder is contained in a content of about 50%.

An image 412 illustrates a mixture in which a metal organic framework particle powder is contained in a content of about 60%. For example, the content may correspond to a volume percent.

The images 410 to 412 illustrate paint coating layers. It shows a decrease in the thicknesses of the paint film layers.

Therefore, the present invention adds metal organic framework particles when producing a radiative cooling paint, so it is not required to thickly paint to form a paint coating layer, thereby improving painting workability.

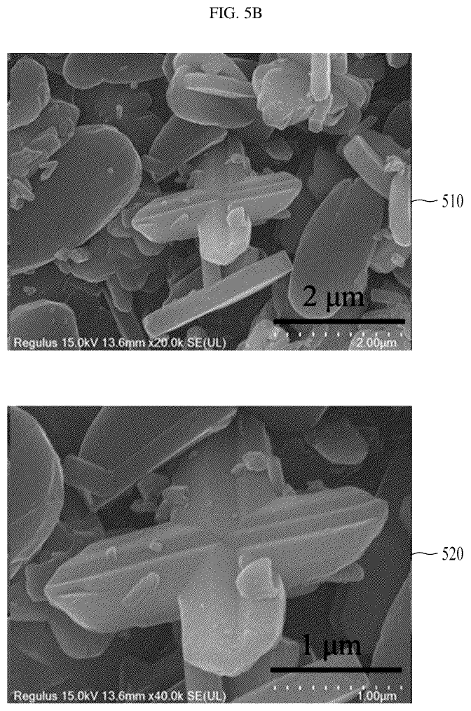

FIGS. 5A and 5B illustrate electron microscope images of a paint coating layer according to an embodiment of the present invention.

FIGS. 5A and 5B illustrate electron microscope images of a paint coating layer according to an embodiment of the present invention.

Referring to FIG. 5A, an electron microscope image 500 of a paint coating layer produced according to an embodiment of the present invention is at a magnification of 10 μm, most particles exist in the form of plates, some thereof exist in the form of overlapping plates, and large surfaces and well-developed internal pores are present.

FIG. 5B illustrates high-magnification images for the image 500 of FIG. 5A. An image 510 is at a magnification of 2 μm, and an image 511 is at a magnification of 1 μm.

Also in the images 510 and 511, it can be seen that many voids are present between metal ions and organic functional groups.

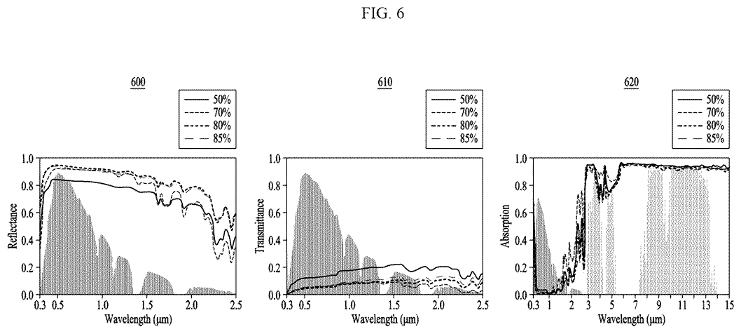

FIGS. 6 to 8 illustrate the optical characteristics of a radiative cooling device including a paint coating layer based on the radiative cooling paint according to an embodiment of the present invention.

In the radiative cooling device including the paint coating layer based on the radiative cooling paint according to an embodiment of the present invention, FIG. 6 illustrates optical characteristics dependent upon a change in the content of metal organic framework particles in a mixture constituting the radiative cooling paint forming the paint coating layer.

Referring to FIG. 6, graph 600 shows a reflectance, graph 610 shows a transmittance, and graph 620 shows an absorbance.

The optical characteristics according to the graphs 600 to 620 are summarized in Table 1 below.

The absorbance of the graph 620 corresponds to the emissivity of Table 1, and the absorbance of Table 1 represents the absorbance of near-infrared rays.

TABLE 1

| Content | Reflectance | Transmittance | Absorbance | Emissivity |
|---|---|---|---|---|
| (%) | (%) | (%) | (%) | (%) |
| 50 | 80.5 | 14.6 | 4.9 | 94.0 |
| 70 | 88.1 | 6.4 | 5.5 | 93.5 |
| 80 | 91.4 | 6.1 | 2.5 | 92.4 |
| 85 | 90.3 | 7.3 | 2.4 | 92.1 |

According to an embodiment of the present invention, the content of metal organic framework particles in the mixture of the radiative cooling paint may be 50% to 85%.

For example, depending upon the content of metal organic framework particles in the mixture of the radiative cooling paint, a reflectance of 80.5% to 90.3% and an emissivity of 92.1% to 94% may be accomplished. Here, the thickness of the radiative cooling paint-based paint coating layer may be about 100 μm.

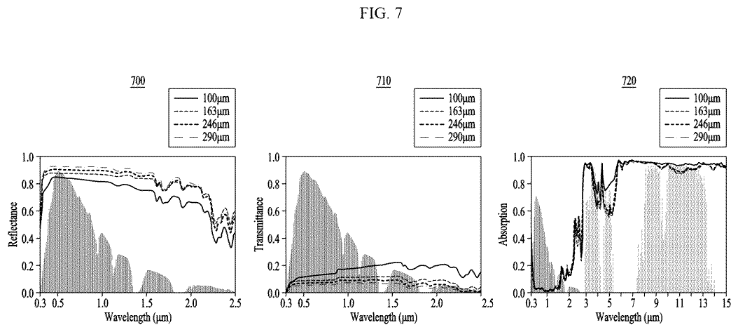

In the radiative cooling device including the paint coating layer based on the radiative cooling paint according to an embodiment of the present invention, FIG. 7 illustrates optical characteristics dependent upon a change in the thickness of the paint coating layer when the content of metal organic framework particles in a mixture constituting the radiative cooling paint forming the paint coating layer is 50%.

Referring to FIG. 7, graph 700 shows a reflectance, graph 710 shows a transmittance, and graph 720 shows an absorbance.

The optical characteristics according to the graphs 700 to 720 are summarized in Table 2 below.

The absorbance of the graph 720 corresponds to the emissivity of Table 2, and the absorbance of Table 2 represents the absorbance of near-infrared rays.

TABLE 2

| Thickness | Reflectance | Transmittance | Absorbance | Emissivity |
|---|---|---|---|---|
| (μm) | (%) | (%) | (%) | (%) |
| 100 | 80.5 | 14.6 | 4.9 | 94.0 |
| 163 | 85.6 | 9.6 | 4.8 | 91.1 |
| 246 | 88.0 | 7.6 | 4.4 | 91.6 |
| 290 | 90.1 | 5.8 | 4.1 | 91.4 |

In the radiative cooling device containing the paint coating layer based on the radiative cooling paint according to an embodiment of the present invention, a reflectance of 80% or more and an emissivity of 91% or more, which correspond to radiative cooling performance, can be accomplished even if the paint coating layer is formed to a thickness of 100 μm to 290 μm when the content of metal organic framework particles in the radiative cooling paint is 50%.

Meanwhile, the absorbance is 4.1% to 4.9% or less, and the transmittance is 5.8% to 14.6%, which prevents temperature rise due to heat absorption.

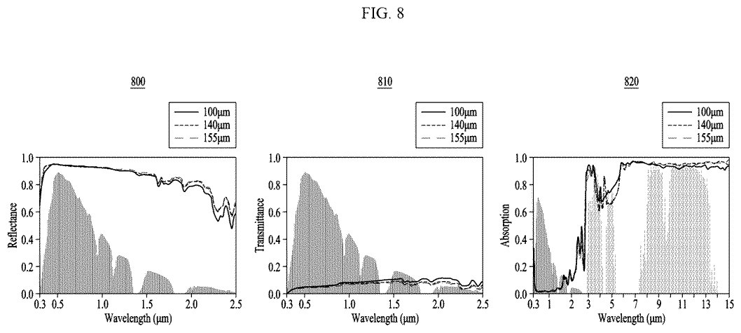

In the radiative cooling device including the paint coating layer based on the radiative cooling paint according to an embodiment of the present invention, FIG. 8 illustrates optical characteristics dependent upon a change in the thickness of the paint coating layer when the content of metal organic framework particles in a mixture constituting the radiative cooling paint forming the paint coating layer is 80%.

Referring to FIG. 8, graph 800 shows a reflectance, graph 810 shows a transmittance, and graph 820 shows an absorbance.

The optical characteristics according to the graphs 800 to 820 are summarized in Table 3 below.

The absorbance of the graph 820 corresponds to the emissivity of Table 3, and the absorbance of Table 3 represents the absorbance of near-infrared rays.

TABLE 3

| Thickness | Reflectance | Transmittance | Absorbance | Emissivity |
|---|---|---|---|---|
| (μm) | (%) | (%) | (%) | (%) |
| 100 | 91.4 | 6.1 | 2.5 | 92.4 |
| 140 | 91.8 | 5.5 | 2.7 | 93.7 |
| 155 | 92.3 | 4.9 | 2.8 | 93.8 |

In the radiative cooling device containing the paint coating layer based on the radiative cooling paint according to an embodiment of the present invention, a reflectance of 91.4% or more and an emissivity of 92.4% or more, which correspond to radiative cooling performance, can be accomplished even if the paint coating layer is formed to a thickness of 100 μm to 140 μm when the content of metal organic framework particles in the radiative cooling paint is 80%.

Meanwhile, the absorbance is 2.5% to 2.8% or less, and the transmittance is 4.9% to 6.1%, which prevents temperature rise due to heat absorption.

Comparing Table 2 with Table 3, it can be seen that, as the content of metal-organic structural particles increases in the mixture constituting the radiative cooling paint under the same thickness condition, the reflectance increases and the transmittance and the absorbance decrease.

That is, the radiative cooling paint can achieve greater or similar radiative cooling performance as the content of metal organic framework particles in the mixture increases, even if the thickness of the paint coating layer is thin.

Therefore, when replacing ceramic particles with metal organic framework particles or adding metal organic framework particles according to the present invention to manufacture a radiative cooling paint, the same or improved radiative cooling performance can be achieved even if the thickness of a paint coating layer is reduced. As a result, painting workability can be improved because thick coating is not required.

In the above-described specific embodiments, elements included in the invention are expressed in singular or plural in accordance with the specific embodiments shown.

It should be understood, however, that the singular or plural representations are to be chosen as appropriate to the situation presented for the purpose of description and that the above-described embodiments are not limited to the singular or plural constituent elements. The constituent elements expressed in plural may be composed of a single number, and constituent elements expressed in singular form may be composed of a plurality of elements.

In addition, the present invention has been described with reference to exemplary embodiments, but it should be understood that various modifications may be made without departing from the scope of the present invention.

Therefore, the scope of the present invention should not be limited by the embodiments, but should be determined by the following claims and equivalents to the following claims.

1. A radiative cooling paint, comprising:
metal organic framework (MOF) particles;
a binder for binding the metal organic framework; and
a solvent in which a mixture of the metal organic framework particles and the binder is dissolved and dispersed,
wherein the binder absorbs and radiates long-wavelength infrared rays of 8 μm to 13 μm, has a plurality of absorption peaks in the long-wavelength infrared rays, and is formed of a polymer resin that does not absorb near-infrared rays in a range of 0.7 μm to 3 μm, and
the metal organic framework particles are formed of a metal material, an organic material and a plurality of voids, scatter and reflect incident sunlight including the near-infrared rays based on a difference in refractive index between the metal organic framework particles and the binder at an interface between the metal organic framework particles and the binder, and additionally scatter and reflect the incident sunlight based on the plurality of voids.

2. The radiative cooling paint according to claim 1, wherein the mixture of the radiative cooling paint further comprises at least one particle of ceramic particles and polymer particles,
wherein the ceramic particles and the polymer particles absorb and radiate the long-wavelength infrared rays, supplement absorption and radiation of long-wavelength infrared rays by the binder to increase emissivity of the long-wavelength infrared rays of 8 μm to 13 μm, and additionally scatter and reflect the incident sunlight based on a difference in refractive index between the binder and the plural voids.

3. The radiative cooling paint according to claim 2, wherein the ceramic particles comprise at least one of TiO₂, Al₂O₃, h-BN, ZrO₂, SiO₂, CaCO₃, BaSO₄, MgO, Y₂O₃, YSZ, BeO, MnO, ZnO, SiC and AlN, and
the polymer particles comprise at least one of dipentaerythritol hexaacrylate (DPHA), polytetrafluoroethylene (PTFE), polydimethylsiloxane (PDMS), polymethyl methacrylate (PMMA), polyurethane acrylate (PUA), ethylene tetra fluoro ethylene (ETFE), polyvinylidene fluoride (PVDF), an acrylic polymer, a polyester-based polymer and a polyurethance-based polymer.

4. The radiative cooling paint according to claim 1, wherein the metal organic framework particles comprise at least one white metal organic framework particle of ZIF-8, MOF-867 and CAU-1.

5. The radiative cooling paint according to claim 1, wherein the metal organic framework particles are comprised in a content ratio of 50% to 85% in the mixture, and when the content ratio increases, a reflectance of the near-infrared rays increases and a transmittance and absorbance thereof are decreased.

6. The radiative cooling paint according to claim 1, wherein the metal organic framework particles have a size of 0.1 μm to 5 μm, and
each of the plurality of voids has a size of less than 5 μm.

7. The radiative cooling paint according to claim 1, wherein the binder comprises a mixture of at least one polymer resin of polyurethane resin, fluorine resin, polyethylene resin, polyacrylate resin, PDMS and PVC.

8. A radiative cooling device, comprising a paint coating layer formed using a radiative cooling paint,
wherein the radiative cooling paint comprises metal organic framework (MOF) particles; a binder for binding the metal organic framework; and a solvent in which a mixture of the metal organic framework particles and the binder is dissolved and dispersed,
wherein the binder absorbs and radiates long-wavelength infrared rays of 8 μm to 13 μm, has a plurality of absorption peaks in the long-wavelength infrared rays, and is formed of a polymer resin that does not absorb near-infrared rays in a range of 0.7 μm to 3 μm, and
the metal organic framework particles are formed of a metal material, an organic material and a plurality of voids, scatter and reflect incident sunlight including the near-infrared rays based on a difference in refractive index between the metal organic framework particles and the binder at an interface between the metal organic framework particles and the binder, and additionally scatter and reflect the incident sunlight based on the plurality of voids.

9. The radiative cooling device according to claim 8, wherein the metal organic framework particles comprise at least one white metal organic framework particle of ZIF-8, MOF-867 and CAU-1.

10. The radiative cooling device according to claim 8, wherein the metal organic framework particles are comprised in a content ratio of 50% to 85% in the mixture, and when the content ratio increases, a reflectance of the near-infrared rays increases and a transmittance and absorbance thereof are decreased.

11. The radiative cooling device according to claim 10, wherein, when the content ratio of the metal organic framework particles in the mixture increases, a reflectance, transmittance and absorbance of the near-infrared rays are maintained even if a coating thickness of the paint coating layer is reduced according to the increased content ratio, and a reflectance of the near-infrared rays increases and a transmittance and absorbance thereof are reduced even if the coating thickness is not changed.

12. The radiative cooling device according to claim 8, wherein the metal organic framework particles have a size of 0.1 μm to 5 μm, and
each of the plurality of voids has a size of less than 5 μm.
